(19) United States
(12) Patent Application Publication
(10) Pub. No.: US 2006/0060295 A1
(43) Pub. Date: Mar. 23, 2006

(54) [METHOD OF MANUFACTURING PLASTIC FOAM POWDER PUFF]

(75) Inventor: Chih-Chun Hsu, TAIPEI (TW)

Correspondence Address: CHIH-CHUN HSU, 2F-4, NO. 148, SEC. 4, CHUNG HSIAO EAST ROAD, TAIPEI, TW

(73) Assignee: Chih-Chun Hsu, Hsin-Yi District, Taipei City (TW)

(21) Appl. No.: 11/163,426

(22) Filed: Oct. 18, 2005

Related U.S. Application Data
(63) Continuation-in-part of application No. 10/711,443, filed on Sep. 20, 2004, now abandoned.

(51) Int. Cl. B32B 37/00; B32B 38/04

(52) U.S. Cl. 156/250; 156/267

(57) ABSTRACT

A method of manufacturing plastic foam powder puffs is provided. First, pluralities of plastic foam powder puff layers and adhesive layers are stacked, wherein the adhesive layers are applied between two adjacent plastic foam powder puff layers (sheets). Next, the adhesive layers are used to adhering the plastic foam powder puff layers together to form a plastic foam powder puff block. Next, the plastic foam powder puff block is cut in a vertical direction, while the first sheet of plastic foam is facing up, to obtain a plurality of plastic foam powder puff slices. Finally, the plastic foam powder puff slices are cut to obtain a plurality of attractive plastic foam powder puffs.

This application is a Continuation-In-Part of my patent application Ser. No. 10/711,443, filed on Sep. 20, 2004.

Method of Manufacturing Plastic Foam Powder Puff

### DESCRIPTION

### BACKGROUND OF THE INVENTION

1. The Field of the Invention

The present invention relates to a method of manufacturing a plastic foam powder puff, and more particularly, to a method of using a plurality of plastic foam powder puff layers with a single color or a variety of colors to produce attractive and colorful plastic foam powder puffs in various sizes, shapes and patterns and thereby add value to the plastic foam powder puffs.

2. Description of Related Art

Human beings like to use all kinds of decorative items, clothes or makeup to demonstrate elegance and beauty, or even the style of different cultures. Different life-style and environments, cultures and backgrounds usually express esthetic sense in the different ways. Before the Eastern and Western cultures intermingled in the early 60's and 70's; in the oriental society, beauty was more conservative, simple and succinct, while the western society demonstrated beauty was more colorful, exciting and brighter. When the eastern and the western cultures were intermingled in the 80's and 90's, it paved a way for the oriental people to experience the western culture, and the oriental gradually accepted the free and unbinding life-style of the western people. Moreover, the oriental people started to express beauty in the same way as the western people. Since, the western life-style has greatly immersed into the eastern society, the western products greatly attracted to everyone in each aspect. The bold expression of the eastern has proven that the western culture has deeply influenced the eastern culture gradually.

To use cosmetic is one of the most effective ways to express beauty. During make up, a person usually uses the conventional cosmetic powder puffs which lacks of any special design and has the following defects listed below.

1. Single color and simple appearance and therefore is too much out fashion to catch up with the trends.

2. The single color and simple designed cosmetic powder puff does not provide attractive and elegant phenomena
3. When using the out fashion cosmetic powder puff, the color and the outlook are not being highlighted.

One conventional method of manufacturing cosmetic powder puff is to combine natural rubber layers and artificial rubber layers with cotton materials, cloth, knitted fabric, so on and so forth. Next, gutta-percha is use to adhere the cotton materials and papers into powder puffs. Then the composite sheet of material is heated in order to make an integral structure. The powder puff has only one side to utilize; therefore, the paper at the bottom is not meant to be utilized. Again, the conventional powder puff is not colorful or in various patterns.

Another conventional method of manufacturing cosmetic pad is to attach a plastic film, a protective layer to protect powder puff from contamination by powder in the packing container. Yet another powder puff manufacturing process consists of having two sheets of, either flock fabric or cloth fabric adhered to each other in order to form the elastic flock powder puff. Thereafter, the elastic flock powder puff is sewed manually, and adhesive is applied to adhere the two sheets of fabrics together to form a powder puff with flock (fluff/nap) on both sides. The adhesive includes latex, which forms a thin film between the two sheets of fabric after the drying process. The elasticity of the latex membrane enables the powder puff to maintain its original shape undergone external pressure. In addition, the tightly knitted material is used at the edge portion of the two flock (nap) fabrics to avoid the latex penetrate there-through and dirty the nap. By adjusting the thickness of the two nap fabrics, the nap may be substantially protected, and also by adjusting the pressure and the tension during the adhering and cutting process, wrinkles may be effectively reduced. Furthermore, the two fabrics would be adhered tightly together by the pressure.

Since both methods mentioned above used similar manufacture techniques to manufacture the powder puff (employed cloth and/or fabric), the color and the shape of the powder puff are still limited.

Therefore, the main goal of the field is to manufacture powder puff in varieties of colors and in different sizes and shapes of the external surface to catch up with the current trends.

### SUMMARY OF THE INVENTION

The present invention's object is to fulfill the disadvantages, functions, and appearance of any other types of powder puff and its manufacturing process. The main object of the present invention is to provide a method of manufacturing a plastic foam powder puff. It consists of sequentially stacking desirable numbers of sheets of plastic foam, and a number of corresponding adhesive layers to form a plastic foam powder puff block, wherein the adhesive layers are applied between two sheets of adjacent plastic foam to adhere the plastic foams together. Each of the plastic foam sheets has different qualities; for example, they all have different color, and they can all be manufactured by different plastic materials in order to provide: different sense of touch, different pore diameters. It reveals the possibility of having different pore diameter on a single plastic foam powder puff in order to satisfy different customers' using habits.

Next, the plastic foam powder puff block is cut in vertical direction to obtain multiple numbers of plastic foam powder puff sheets (FIG. 3). Furthermore, a plurality of dies with different or same shapes and sizes are used to cut the plastic foam powder puff sheets into desirable shapes and sizes. Both sides of the plastic foam powder puff may be utilized.

This method of manufacturing plastic foam powder puff is not only cost effective but also it is possible to produce attractive and colorful plastic foam powder puffs and add value to the plastic foam powder puffs. It also provides new functionality: to have different pore diameters of plastic foam on a single powder puff, which will enable our customers to apply powders with different density and pressure. This new manufacturing process will also help us to save resources because we will be able to turn what originally unusable foam sheets into powder puff. A large number of useless foam sheets will be excluded from other traditional production lines. Thus with this new invention, we could turn what's originally trash into valuable powder puff.

According to another aspect of the present invention, plastic foam powder puff foam in plurality layers of a single color or a variety of colors can be stacked together to produce an attractive and colorful plastic foam powder puff that is capable of stimulating the mood of users. They will be deeply appreciated.

### BRIEF DESCRIPTION OF THE FIGURES

FIG. 1 is an elevational view of the plastic foam powder puff block according to an embodiment of the present invention.

FIG. 2 is a divided view showing arrangement of a plurality of plastic foam powder puff layers and adhesive layers according to an embodiment of the present invention.

FIG. 3 is an elevation view that shows the step of cutting the plastic foam powder puff block to the plastic foam powder puff slice according to an embodiment of the present invention.

FIG. 4 is an elevation view that shows the step of trimming and slicing the plastic foam powder puff foam according to an embodiment of the present invention.

FIG. 5 is an elevation view that shows the step of cutting and slicing the plastic foam powder puff foam block according to another embodiment of the present invention.

FIG. 6 is an elevation view illustrating a step of cutting out the pile of plastics foam by means of dies to produce the plastic foam powder puff, according to an embodiment of the present invention.

FIG. 7 is an elevation view that shows the plastic foam powder puff foam in varieties of shapes, sizes and patterns according to various embodiments of the present invention.

### DETAILED DESCRIPTION OF PREFERRED EMBODIMENTS

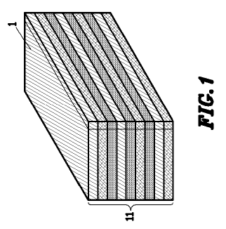

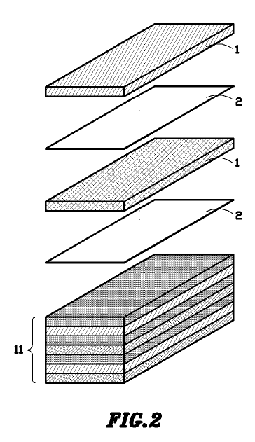

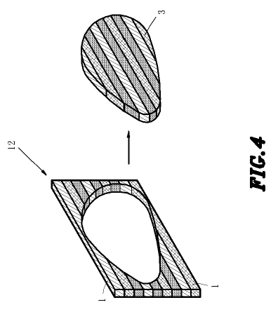

FIGS. 1, 2, 3 and 4, represent the method of manufacturing the multi-layer, multi-colored powder puff of the present invention.

(1) First, a plastic foam powder puff foam in plurality layers 1 is stacked in an order;
(2) Adhesive layers 2 are respectively applied between the plastic foam powder puff foam layers 1;

(3) Through a thermal process, the adhesive layers 2 adhere the plastic foam powder puff layers 1 together to form a plastic foam powder puff foam block 11;

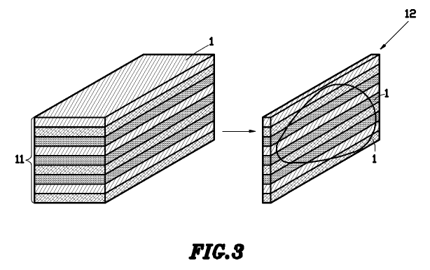

(4) The plastic foam powder puff foam block 11 is then cut in a vertical direction, as shown in FIG. 3, to obtain a plurality of plastic foam powder puff slices 12; and

(5) The plastic foam powder puff foam slices 12 are finally cut by means of using a single die or multiple dies to form multiple number of plastic foam powder puffs 3 with desired shape and pattern, wherein both sides of the plastic foam powder puffs 3 may be utilized.

The plastic foam powder puffs 3 manufactured according to the above described method comprises various colors or a single color by stacking the plurality of plastic foam powder puff layers 1 with various colors together to form the plastic foam powder puff block 11, and then cut the foam powder puff plastic block 11 along a vertical direction with the first sheet of plastic foam facing up. Accordingly, the plastic foam powder puff 3 can be manufactured with a desired color(s) and patterns by arranging the plastic foam powder puff layers 1 in desired order, and the thermal treatment process will create an integral structure. Therefore, the method of the present invention is capable of producing attractive and colorful plastic foam powder puffs 3 that are appealing to users, which can stimulate the mood of the user while using the plastic foam powder puffs 3 making their make-up process extremely pleasant. This manufacturing process will also help us to save resources by salvaging unwanted, flawed sheet of plastic foam into valuable powder puff.

The plastic foam powder puff layer 1 may be comprised of plastic resin material, petroleum material, natural rubber or artificial rubber, and may be manufactured via injection molding process, which consists of injecting raw materials into a metal mold to manufacture plastic foam sheets. Thus, the plastic foam powder puff layer 1 may be manufactured easily and effectively in a short time compared to the conventional art.

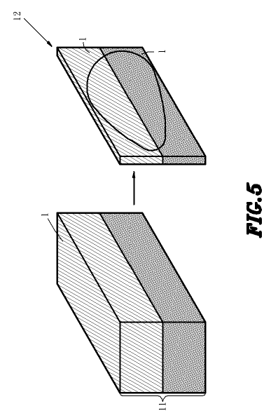

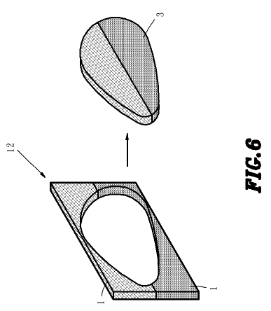

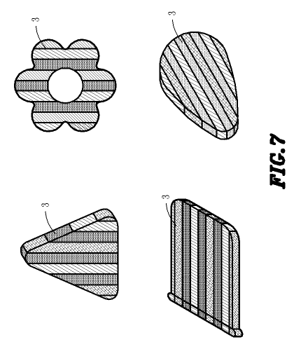

Referring to FIGS. 5, 6 and 7, the plastic foam powder puff layer 1 can comprise a single color or a variety of colors. For example, the plastic foam powder puff layer 1 comprising at least two different colors of a desired pattern can be utilized to produce the plastic foam powder puff block 11, and then the plastic foam powder puff block 11 is cut to obtain the plastic foam powder puff slices 12. Thus, the plastic foam powder puff slices 12 with desired shapes, colors and patterns could be manufactured by the method of the present invention. Accordingly, by using the plastic foam powder puff layers 1 with a variety of attractive colors, the plastic foam powder puff blocks 11 of desired colors and shapes can be produced, and thereafter the plastic foam powder puff block 11 can be cut to obtain the plastic foam powder puff slices 12 and then the plastic foam powder puff slices 12 are trimmed by the die to obtain the attractive and colorful plastic foam powder puffs 3. Thus, the plastic foam powder puff 3 can be substantially different and more attractive compared to the conventional cosmetic powder puffs.

The plastic foam powder puff 3 of the present invention has following advantages.

1. Attractive and colorful plastic foam powder puffs 3 of a various sizes and shapes can be produce to stimulate the mood of users to impart better makeup effects.

2. Attractive and colorful plastic foam powder puffs 3 can be designed into desirable shapes and sizes that are appealing to users and thereby add value to the plastic foam powder puffs 3 and promote the sales of the plastic foam powder puffs 3 on the market.

3. Different colored plastic foam powder puff layers 1 in desirable shapes, patterns and sizes can be utilized to produce attractive plastic foam powder puffs 3, wherein both sides of the plastic foam powder puffs 3 may be utilized.

4. The users can enjoy the above advantages and benefits provided by the plastic foam powder puffs 3 of the present invention.

5. The waste materials or inferior goods from this or any other manufacturing processes, which turn up foam sheets, can be recycled which will substantially reduce the manufacturing cost.

6. These new plastic foam powder puff could contain different pore diameters. The advantage of having different pore diameters on a single powder puff is to enable customer to apply powder on to their skin with different density and pressure.

7. These new plastic foam powder puff could be made from different plastic foam sheets; for example, the first layer is made by PU, second layer is made by NBR latex, third layer is made by SBR latex etc. . . . Having a single powder puff consists of different plastic foams will give it different physical qualities on different sides. For example, a plastic foam powder puff may be rough (have a relatively larger pore diameter) on the one side, and smooth (have a relatively smaller pore diameter) on the other side, or having a different density thus, one part of powder puff is firm, solid and the other part is soft, flexible.

A prototype of plastic foam powder puff has been constructed with the features of FIGS. 1˜7. The plastic foam powder puff functions smoothly to provide all of the features discussed earlier.

Although a particular embodiment of the invention has been described in detail for purposes of illustration, various modifications and enhancements may be made without departing from the spirit and the scope of the invention.

What is claimed is:

1. A method of manufacturing plastic foam powder puffs, comprising the steps of:
(i) providing a plurality of plastic foam powder puff layers (sheets of plastic foam);
(ii) Applying permanent adhesive layers between said plastic foam powder puff layers respectively;
(iii) using said adhesive layers to adhere said plastic foam powder puff layers to form a plastic foam powder puff block;
(iv) cutting said plastic foam powder puff block in a vertical direction to obtain multiple plastic foam powder puff slices by means of using metal dies; and
(v) Cutting said plastic foam powder puff slices to obtain a plurality of plastic foam powder puffs by means of dies.

2. The method of manufacturing plastic foam powder puffs according to claim 1, wherein said plurality of plastic foam powder puff layers are stacked in an orderly manner.

3. The method of manufacturing plastic foam powder puffs according to claim 1, wherein said plastic foam powder puff layers comprise a single color or a variety of colors.

4. The method of manufacturing plastic foam powder puffs according to claim 1, wherein said plastic foam powder puff slice can be cut into different shape and size to form said plastic foam powder puffs with a variety of patterns.

5. The method of manufacturing foam powder puffs according to claim 1, the plastic foam powder puff will consist of various physical qualities such as density, diameter, weight, firmness, softness and strength etc. . . . on various parts of powder puff depending on the different plastic foam layers. The engineer will be able to design a powder puff, which consist of different physical properties in various parts of the plastic foam powder puff.

6. The method of manufacturing foam powder puffs according to claim 1, the final product of powder puff could consist of different designated size of pore diameter on various parts of powder puff. The engineer could designate layers of plastic foam sheets according to their physical properties. Therefore, the engineer could control the pore diameter for different parts of powder puff.
